(19) United States
(12) Patent Application Publication
(10) Pub. No.: US 2026/0181683 A1
(43) Pub. Date: Jun. 25, 2026

(54) OPERATING A SCHEDULER OF AN ACCESS POINT OF A RADIO ACCESS NETWORK (RAN)

(71) Applicant: Deutsche Telekom AG, Bonn (DE)

(72) Inventor: Dominik Schnieders, Aachen (DE)

(21) Appl. No.: 19/415,834

(22) Filed: Dec. 11, 2025

(30) Foreign Application Priority Data
Dec. 20, 2024 (EP) 24 222 313.9

(51) Int. Cl. H04W 72/543; H04W 72/12

(52) U.S. Cl. CPC H04W 72/543; H04W 72/12

(57) ABSTRACT

A method for operating a scheduler of an access point of a radio access network (RAN) includes: forwarding, by the access point of the RAN, data packets from a distributed real-time application via a wireless connection provided by the access point; allocating, by the scheduler of the access point, spectral resources to the wireless connection; successively determining, by the scheduler, target data rates for the distributed real-time application; and adapting, by the distributed real-time application, a data rate of the transmitted data packets to a determined target data rate signaled by the scheduler via an application programming interface (API) of the distributed real-time application.

### CROSS-REFERENCE TO PRIOR APPLICATIONS

This application claims benefit to European Patent Application No. EP 24 222 313.9, filed on Dec. 20, 2024, which is hereby incorporated by reference herein.

### FIELD

The invention relates to a method for operating a scheduler of an access point of a radio access network (RAN), wherein an access point of a radio access network forwards data packets transmitted by the distributed real-time application via a wireless connection provided by the access point and a scheduler of the access point allocates spectral resources to the wireless connection. The invention further relates to a distributed real-time application, an access point for a radio access network, a radio access network and a computer program product.

### BACKGROUND

Distributed real-time applications are to be provided with a low and stable latency of the wireless connection. Latency corresponds to an unavoidable transmission delay related to the wireless connection. A stability of the latency corresponds to a low volatility of the latency wherein the volatility of the latency is usually referred to as a jitter.

US 2024/214320 A1 describes a method for operating a communication network, wherein a distributed real-time-application transmits data packets via the communication network at a data rate exploiting a currently available bitrate provided by the communication network and immediately reduces the data rate by a difference signaled by a scheduler of the communication network, the scheduler anticipating the currently available bitrate to drop by the difference.

US 2024/195746 A1 describes a method for operating a communication network, wherein a distributed real-time-application transmits data packets via the communication network at a data rate lower by an offset than a target bitrate signaled by a scheduler of the communication network and the scheduler learns the offset and guarantees a minimum bitrate higher by the learned offset than a minimum operable data rate defined by the distributed real-time application.

US 2024/349263 A1 describes a method for operating a communication network, wherein a distributed real-time-application transmits data packets at a data rate via the communication network; a scheduler of the communication network assigns a priority to the data packets and assigns corresponding spectral resources and marks data packets exceeding the assigned spectral resources, the marked data packets causing the distributed real-time application to reduce the data rate.

In greater detail, a sender of the distributed real-time application transmits the data packets via the wireless connection at a data rate, the data rate immediately depending on a size and an incidence, i.e. a frequency of the transmitted data packets.

The sender is executed by a first node and the receiver is executed by a second node remote from the first node, the sender and the receiver transmitting data packets via the wireless connection. Alternatively, the first node may execute the receiver while the second node may execute the sender. Of course, the first node and the second node may also alternate in executing the sender and the receiver, respectively, during execution of the distributed real-time application.

The distributed real-time application, herein, may also be a near-real-time application and requires a low and stable latency in order to function properly. Autonomous driving, online gaming and video calling are exemplary distributed real-time applications.

For instance, the scheduler may signal the determined target data rate indirectly by applying a low latency low loss scalable throughput (L4S) algorithm to a queue controlled by the scheduler. The L4S algorithm is specified by RFC 9330 and uses an explicit congestion notification (ECN) protocol exploiting bits of an internet protocol (IP) header of the data packets for signaling a filling level of the queue.

However, the LAS algorithm requires the scheduler to consecutively measure waiting times of the transmitted data packets in the queue and occasionally mark the transmitted data packets. Apart from that, the distributed real-time application has to strictly check received data packets for marks inserted by the scheduler and evaluate a percentage of received data packets having a mark.

### SUMMARY

In an exemplary embodiment, the present invention provides a method for operating a scheduler of an access point of a radio access network (RAN). The method includes: forwarding, by the access point of the RAN, data packets from a distributed real-time application via a wireless connection provided by the access point; allocating, by the scheduler of the access point, spectral resources to the wireless connection; successively determining, by the scheduler, target data rates for the distributed real-time application; and adapting, by the distributed real-time application, a data rate of the transmitted data packets to a determined target data rate signaled by the scheduler via an application programming interface (API) of the distributed real-time application.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 schematically shows a radio access network (RAN) according to an embodiment of the invention.

### DETAILED DESCRIPTION

Exemplary embodiments of the invention provide a method for operating a scheduler of an access point of a radio access network (RAN), which allows for providing a distributed real-time application with a wireless connection having a very stable latency and avoids the L4S algorithm. Further exemplary embodiments of the invention provide a distributed real-time application, an access point for a radio access network, a radio access network and a computer program product.

A first aspect of the invention is a method for operating a scheduler of an access point of a radio access network (RAN) wherein an access point of a radio access network forwards data packets transmitted by the distributed real-time application via a wireless connection provided by the access point and a scheduler of the access point allocates spectral resources to the wireless connection. The scheduler also allocates spectral resources to different wireless connections simultaneously used by competing distributed applications transmitting data packets to be forwarded by the access point.

According to the invention, the scheduler successively determines target data rates for the distributed real-time application and the distributed real-time application immediately adapts a data rate of the transmitted data packets to a determined target data rate signaled by the scheduler via an application programming interface (API) of the distributed real-time application. The scheduler does not apply an LAS algorithm to the transmitted data packets and, hence, neither measures the scheduler waiting times of the transmitted data packets in a queue of the access point nor marks the scheduler any transmitted data packet. Instead, the scheduler directly controls the data rate of the distributed real-time application signaling the target data rate via the API. Thereby, the scheduler relies on practically instantaneous adequate reactions of the distributed real-time application to changes of the signaled target data rate. Herein, the terms “immediately” and “practically instantaneous”, respectively, mean “delayed only by a transmission time, a processing time and the like”.

It is explicitly noted that the scheduler is not required to signal each determined target data rate (see below).

Preferably, the target data rate may be determined dependent on totally available spectral resources and on determined fair spectral resources. The access point provides a constant amount of spectral resources which are fairly distributed among competing distributed applications simultaneously using wireless connections provided by the access point.

The scheduler may determine the fair spectral resources dependent on a number of competing distributed applications. A distribution of the spectral resources among the wireless connections used by N competing distributed applications including the distributed real-time application is fair in case each wireless connection is allocated to an at least approximately equal portion Resₐₚₚ of the totally available spectral resources Resₐᵥₐᵢₗ.

$${Res}_{app} = \frac{1}{N} \times {Res}_{avail}$$

This fair distribution corresponds to N mobile broadband (MBB) users all having the lowest priority according to QCI9 or 5QI9. The scheduler may determine the fair spectral resources further dependent on a respective quality of service, QoS, required by each competing distributed application, particularly required by the distributed real-time application. The QoS may be specified by a policy and charging rules function (PCRF) or a policy control function (PCF) of the radio access network. The QoS is, however, not explicitly taken into account herein for the sake of an easier understanding. The fair distribution is also referred to as a best effort distribution.

The scheduler may assign a priority to the data packets transmitted by the distributed real-time application and allocate spectral resources corresponding to the assigned priority. For instance, the distributed real-time application may be favored over the competing distributed applications by assigning a relative priority, i.e., involving an, e.g., integer multiple Z>1 in determining the spectral resources Resₐₚₚ allocated to the wireless connection of the distributed real-time application.

$${Res ( Z )}_{app} = \frac{Z}{N + Z - 1} \times {Res}_{avail}$$

Accordingly, each competing distributed application is allocated spectral resources Res_{comp} according to

$${Res}_{comp} ( Z ) = \frac{1}{N + Z - 1} \times {Res}_{avail}$$

Alternatively, the scheduler may assign an absolute priority to the data packets transmitted by distributed real-time application, the absolute priority corresponding to an infinite Z, the absolute priority allowing the distributed real-time application for using the totally available spectral resources.

The scheduler may determine the spectral resources additionally dependent on a condition of the wireless connection. The priority of the distributed real-time application and competing applications and, hence, the respective allocated spectral resources may be temporarily increased in case the condition of the wireless connection temporarily deteriorates, e.g., when mobile devices are located in a marginal region of the radio cell.

$${Res}_{app} ( Z ) = \frac{Z + P {F}_{app}}{N + Z - 1 + P {F}_{a p p} - 1 + M \times P {F}_{c o m p} - M} \times {Res}_{a v a i l}$$

Herein, PFₐₚₚ>1 denotes the integer proportional fair, PF, priority of the distributed real-time application, M denotes the number of competing applications suffering from bad conditions of their wireless connections and PF_{comp}>1 denotes the respective proportional fair priority of each competing application.

The scheduler may determine the spectral resources dependent on spectral resources allocated to but unused by competing distributed applications. The assigned but unused spectral resources may be taken into account by a corrective factor K>0 denoting a percentage of the totally available spectral resources.

$${Res}_{app} ( Z ) = ( \frac{Z + P {F}_{a p p}}{N + Z - 1 + P {F}_{app} - 1 + M \times P {F}_{comp} - M} + K ) \times {Res}_{avail}$$

The scheduler may steadily vary the corrective factor K dependent on a current degree of usage of the spectral resources allocated to the wireless connections of the competing distributed applications and on a usage of massive multiple in multiple out (MIMO) in the radio cell.

Additionally, the scheduler may determine the spectral resources dependent on a communication overhead related to the wireless connection. The communication overhead may comprise system messages and the like.

The target data rate may be determined dependent on a symbol time, a modulation scheme and/or a Multiple Input Multiple Output (MIMO) configuration of a mobile device executing a frontend of the distributed real-time application. Starting from the allocated spectral resources the scheduler may determine the target data rate DRₐₚₚ according to

$$D {R}_{app} = \frac{1 s}{{t}_{Symb}} \times {Res}_{app} ( 1 ) \times {QAM}_{Mod} \times {MIMO}_{U E} ,$$

wherein t_{Symb} denotes a symbol transmission time, QAM_{Mod} denotes a factor corresponding to the modulation scheme and MIMQ_{UE} takes into account a MIMO capability of the UE wirelessly connected to the radio access point and executing the frontend of the distributed real-time application.

It is noted that the signaled data rate DRₐₚₚ is lower than a data rate corresponding to the actually allocated spectral resources Resₐₚₚ(Z) for Z>1. The resulting headroom of spectral resources may be distributed by the scheduler among the wireless connections used by the competing distributed applications while the headroom is not used by the distributed real-time application. However, the headroom may be used by the distributed real-time application, e.g., in case the functional minimum data rate is exceptionally signaled instead of the determined target data rate corresponding to the determined fair spectral resources.

Preferably, the scheduler signals the determined target data rate when a difference of the determined target data rate from the last signaled target data rate exceeds a predetermined threshold. The predetermined threshold defines an acceptable range of deviations of the determined data rate. The determined target data rate is, hence, only signaled when the determined target data rate exits the acceptable range. In other words, the predetermined threshold specifies a hysteresis avoiding or at least delaying the signaling in case a current state of the radio cell or a condition of the wireless connection varies. The predetermined threshold may be manually adjustable by an operator of the radio access network within a range from 100 Kbps to 5 Mbps. The acceptable range may be asymmetric, i.e., different thresholds may be predetermined for a positive difference and a negative difference.

Alternatively or additionally, the data rate is determined averaged over a sliding window, a width of the sliding window being in a range from 5 ms to 50 ms and preferably being 10 ms. The averaging over the sliding window avoids the signaling in case positive differences and negative differences from the last signaled target data rate are balanced, i.e., cancel out, within the sliding window.

A combination of the two preceding features most effectively prevents the determined target data rate from being signaled too often and, thus, protects the API and the distributed real-time application from being unduly loaded due to the signaling.

The scheduler may signal the determined target data rate at once when the determined target data rate suddenly drops by a large amount. The determined target data rate drops suddenly by a large amount in case the determined target data rate strongly decreases within a very short time interval.

The target data rate may be determined periodically. A frequency of the determination is favorably chosen to sufficiently take into account changes of the state of the radio cell and the condition of the wireless connection and, at the same time, to avoid an adverse load of the access point and the RAN. It is noted that higher frequencies of the determination of the target bitrate imply smaller steps of signaled target data rates and, hence, a greater smoothness of the adaptations of the distributed real-time application.

In a favorable embodiment, the distributed real-time application initially transmits a functional minimum data rate of the distributed real-time application to the scheduler and the scheduler exceptionally determines the target data rate to be the functional minimum data rate when the normally determined target data rate is lower than the functional minimum data rate. This way, the scheduler prevents the distributed real-time application from temporarily freezing or even aborting.

The real-time application may define the minimum functional data rate being a data rate allowing just a minimum function of the distributed real-time application. In other words, the distributed real-time application does not function at data rates below the functional minimum data rate. In case the data rate falls below the functional minimum data rate the distributed real-time application freezes, i.e., at least temporarily stops functioning or even aborts.

A frontend of the distributed real-time application may be executed by a mobile device and a backend of the distributed real-time application may be executed by an edge data center. Due to the edge data center being logically close, usually also spatially close to the access point, the wireless connection used by the distributed real-time application has a very low latency.

Another aspect of the invention is a distributed real-time application, comprising an application programming interface (API). The scheduler may signal the target data rate to an application frontend of the distributed real-time application or to an application backend of the distributed real-time application. The application frontend may be executed by a mobile device, i.e., user equipment (UE). The application backend may be executed by a server device connected to the radio access network. The API may allow for in-band signaling or out-of-band signaling.

According the invention, the distributed real-time application is configured for immediately adapting a data rate of data packets transmitted by the distributed real-time application to a target data rate signaled via the application programming interface. The immediate adaptation of the data rate allows a real-time control of the data rate for the scheduler. Thus, the scheduler can change a distribution of spectral resources assigned among competing distributed applications very flexibly dependent on a current state of the radio cell or a current condition of the wireless connection and rely on practically instantaneous adequate reactions of the distributed real-time application to such changes.

A third aspect of the invention is an access point for a radio access network (RAN) comprising a computing device configured for operating a scheduler. The access point may be generally referred to as a base transceiver station (BTS). During an operation of the scheduler the scheduler assigns spectral resources to wireless connections provided by the access point.

According to the invention, the computing device is configured to operate the scheduler cooperating with a distributed real-time application according to an embodiment of the invention in a method according to the invention. Due to the respective configurations of the access point and the distributed real-time application the access point provides the distributed real-time application with a wireless connection having a low and stable latency without applying an L4S algorithm.

A fourth aspect of the invention is a radio access network (RAN). The RAN may provide wireless connections to mobile devices. In detail, access points of the RAN establish radio cells allowing mobile devices located within the radio cell to connect to the RAN via the access point.

According to the invention, the radio access network comprises an access according to the invention. Due to the access point the RAN provides the distributed real-time application with a wireless connection having a low and stable latency without applying an L4S algorithm.

A fifth aspect of the invention is a computer program product, comprising a digital storage media with a program code. The digital storage medium is chosen from the group comprising a compact disk (CD) a digital versatile disk (DVD) a hard disk (HD) a random access memory (RAM) chip, a universal serial bus (USB) stick, a cloud storage and the like. The computer program product allows for implementing exemplary embodiments of the inventive access point of a RAN, i.e., for setting up the scheduler on the computing device, the computing device being comprised by the access point.

According to the invention, the program code causes a computing device to operate a scheduler cooperating with a distributed real-time application according to an embodiment the invention in a method according to an embodiment of the invention when being executed by a processor of the computing device. The computer program product enables the computing device to be an exemplary embodiment of the inventive access point of a RAN, the access point providing a distributed real-time application with a wireless connection having a low and stable latency without applying an LAS algorithm.

It is an advantage of exemplary embodiments of the inventive method that the distributed real-time application is provided with a wireless connection having a low and stable latency without applying an LAS algorithm. As a consequence, the distributed real-time application is efficiently and reliably prevented from freezing or even aborting.

It shall be understood that the features described previously and to be described subsequently may be used not only in the indicated combinations but also in different combinations or on their own without leaving the scope of the present invention.

The invention is described in detail via an exemplary embodiment and with reference to the drawings. Like components are indicated by like reference numerals throughout the drawings.

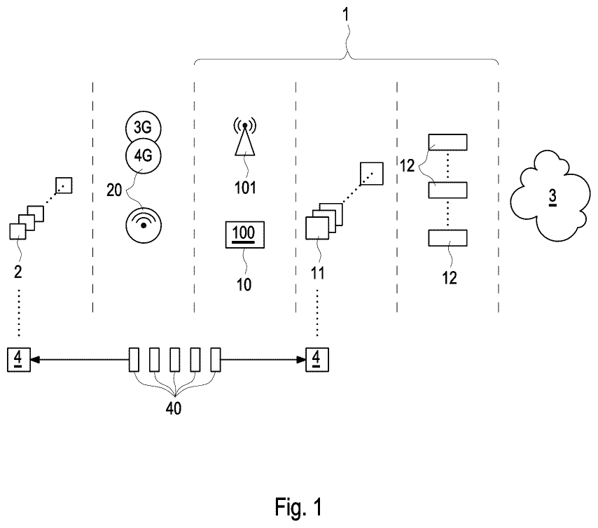

FIG. 1 schematically shows a radio access network (RAN) 1 according to an embodiment of the invention. The RAN 1 comprises at least one access point 10 according to an embodiment of the invention and an antenna 101 connected to the access point 10, generally a plurality of access points 10 with respective connected antennas 101. Exemplarily, the radio access network 1 is configured as a cellular network, and the at least one access point 10 is configured as a base transceiver station (BTS). Alternatively, the radio access network 1 may be configured as a wide local area network (WLAN) and the at least one access point 10 may be a WLAN access point.

The radio access network 1 may further comprise an edge data center 11 adjacent and connected to the at least one access point 10 and a backbone 12 the edge data center 11 is connected to. An internet 3 may be connected to the backbone 12.

At least one mobile device 2, e.g., a smartphone, a tablet, a notebook and the like, generally a plurality of mobile devices 2, may be connected to the at least one access point 10 via a wireless connection 20 provided by the at least one access point 10. The mobile device 2 may comprise a sender of a distributed real-time application 4.

The distributed real-time application 4 comprises an application programming interface (API) and is configured for immediately adapting a data rate of data packets transmitted by the distributed real-time application 4 to a target data rate signaled via the application programming interface.

The edge data center 11 may comprise a receiver of the distributed real time application 4. Alternatively, the mobile device 2 may comprise the receiver of the distributed real-time application 4, and the edge data center 11 may comprise the sender of the distributed real-time application 4. The sender of the distributed real-time application is configured for transmitting data packets 40 via the wireless connection 20 to the receiver of the distributed real-time application 4.

The at least one access point 10 comprises a scheduler 100, more precisely a computing device being configured for operating the scheduler 100. The computing device is particularly configured via a computer program product comprising a digital storage medium storing a program code. The program code causes the computing device for operating the scheduler 100 cooperating with the distributed real-time application 4 in a method according to an embodiment of the invention when being executed by a processor of the computing device.

The scheduler 100 of the access point 10 of the radio access network (RAN) 1 is operated by the computing device in a method according to the invention as follows, the scheduler 100 cooperating with the distributed real-time application 4.

The access point 10 of a RAN 1 forwards data packets 40 transmitted by the distributed real-time application 4 via a wireless connection 20 provided by the access point 10. Particularly, a frontend of the distributed real-time application 4 may be executed by the mobile device 2, and a backend of the distributed real-time application 4 may be executed by the edge data center 11.

The scheduler 100 successively determines target data rates for the distributed real-time application 4. Preferably, the target data rate is determined periodically. The target data rate may be determined averaged over a sliding window, a width of the sliding window being in a range from 5 ms to 50 ms and preferably being 10 ms.

The scheduler 100 preferably determines the target data rate dependent on totally available spectral resources and on determined fair spectral resources. The target data rate may be determined dependent on a symbol time, a modulation scheme and/or a Multiple Input Multiple Output, MIMO, configuration of the mobile device executing the frontend of the distributed real-time application 4. The scheduler 100 may determine the fair spectral resources dependent on a number of competing distributed applications, on a condition of the wireless connection 20 and/or on spectral resources allocated to but unused by competing distributed applications.

The scheduler 100 of the access point 10 allocates spectral resources to the wireless connection 20. The scheduler 100 may assign a priority to the data packets transmitted by the distributed real-time application 4 and allocate spectral resources corresponding to the assigned priority.

The distributed real-time application 4 immediately adapts a data rate of the transmitted data packets 40 to a determined target data rate signaled by the scheduler 100 via an application programming interface (API) of the distributed real-time application 4. The scheduler 100 may signal the determined target data rate when a difference of the determined target data rate from the last signaled target data rate exceeds a predetermined threshold, the predetermined threshold being manually adjustable by an operator of the radio access network within a range from 100 Kbps to 5 Mbps. However, the target data rate may be signaled at once when the determined target data rate suddenly drops by a large amount.

Favorably, the distributed real-time application 4 initially transmits a functional minimum data rate of the distributed real-time application 4 to the scheduler 100 and the scheduler 100 exceptionally determines the target data rate to be the functional minimum data rate when the normally determined target data rate is lower than the functional minimum data rate.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 radio access network
10 access point
100 scheduler
101 antenna
11 edge data center
12 backbone
2 mobile device
20 wireless connection
3 internet
4 distributed real-time application
40 data packet

1. A method for operating a scheduler of an access point of a radio access network (RAN), comprising:
forwarding, by the access point of the RAN, data packets from a distributed real-time application via a wireless connection provided by the access point;
allocating, by the scheduler of the access point, spectral resources to the wireless connection;
successively determining, by the scheduler, target data rates for the distributed real-time application; and
adapting, by the distributed real-time application, a data rate of the transmitted data packets to a determined target data rate signaled by the scheduler via an application programming interface (API) of the distributed real-time application.

2. The method according to claim 1, wherein the scheduler determines the target data rate dependent on totally available spectral resources and on determined fair spectral resources.

3. The method according to claim 2, wherein the scheduler determines the fair spectral resources dependent on:
a number of competing distributed applications,
a condition of the wireless connection, and/or
spectral resources allocated to but unused by competing distributed applications.

4. The method according to claim 1, wherein the scheduler assigns a priority to the data packets transmitted by the distributed real-time application and allocates spectral resources corresponding to the assigned priority.

5. The method according to claim 1, wherein the target data rate is determined dependent on a symbol time, a modulation scheme, and/or a Multiple Input Multiple Output (MIMO) configuration of a mobile device executing a frontend of the distributed real-time application.

6. The method according to claim 1, wherein the scheduler signals the determined target data rate based on a difference of the determined target data rate from the last signaled target data rate exceeding a predetermined threshold, wherein the predetermined threshold is manually adjustable by an operator of the radio access network within a range from 100 Kbps to 5 Mbps.

7. The method according to claim 1, wherein the target data rate is averaged over a sliding window, wherein a width of the sliding window is in a range from 5 ms to 50 ms.

8. The method according to claim 1, wherein the target data rate is signaled in response to a drop in the determined target data rate.

9. The method according to claim 1, wherein the target data rate is determined periodically.

10. The method according to claim 1, wherein the distributed real-time application initially transmits a functional minimum data rate of the distributed real-time application to the scheduler, and the scheduler exceptionally determines the target data rate to be the functional minimum data rate based on the normally determined target data rate being lower than the functional minimum data rate.

11. The method according to claim 1, wherein a frontend of the distributed real-time application is executed by a mobile device, and a backend of the distributed real-time application is executed by an edge data center.

12. A system, comprising:
a first device configured to executed a frontend of a distributed real-time application; and
a second device configured to execute a backend of the distributed real-time application;
wherein the distributed real-time application comprises an application programming interface (API); and
wherein the distributed real-time application is configured to adapt a data rate of data packets transmitted by the distributed real-time application to a target data rate signaled via the application programming interface.

13. The system according to claim 12, further comprising:
an access point for a radio access network (RAN), wherein the access point is configured to operate a scheduler cooperating with the distributed real-time application.

14. The system according to claim 13, further comprising:
the RAN.

15. A non-transitory computer-readable medium having processor-executable instructions stored thereon for operating a scheduler of an access point of a radio access network (RAN), wherein the processor-executable instructions, when executed, facilitate:
forwarding, by the access point of the RAN, data packets from a distributed real-time application via a wireless connection provided by the access point;
allocating, by the scheduler of the access point, spectral resources to the wireless connection;
successively determining, by the scheduler, target data rates for the distributed real-time application; and
adapting, by the distributed real-time application, a data rate of the transmitted data packets to a determined target data rate signaled by the scheduler via an application programming interface (API) of the distributed real-time application.
